(19) United States
(12) Patent Application Publication
(10) Pub. No.: US 2012/0089899 A1
(43) Pub. Date: Apr. 12, 2012

(54) METHOD AND SYSTEM FOR REDISPLAYING A WEB PAGE

(75) Inventors: Mark P. Palaima, Saratoga, CA (US); Yitao Yao, Saratoga, CA (US)

(73) Assignee: eBay Inc., San Jose, CA (US)

(21) Appl. No.: 12/901,918

(22) Filed: Oct. 11, 2010

(51) Int. Cl. G06F 17/00

(52) U.S. Cl. 715/234

(57) ABSTRACT

A method and system for redisplaying a web page is provided. An example method comprises accessing a web page received at a computer system, analyzing the structured text of the web page, and identifying a plurality of content sections. A rendering module renders a web page view comprising the plurality of sections.

### TECHNICAL FIELD

This application relates to the technical fields of software and/or hardware technology and, in one example embodiment, to system and method for redisplaying a web page.

### BACKGROUND

A document that can be provided on the World Wide Web and can be accessed through a web browser and displayed on a computer screen is usually referred to as a web page. A web page may be represented using a hierarchical markup language, such as, e.g., HyperText Markup Language (HTML) or eXtended HyperText Markup Language (XHTML). A web page may include substantive textual content (e.g., an article or a blog entry), and may also include navigation to other web pages via hypertext links, as well as advertisements. Information pertaining to layout, typographic and color-scheme information may be provided for a web page by Cascading Style Sheet (CSS) instructions that may be embedded in the associated HTML file. An HTML file associated with a web page may also include computer code (e.g., JavaScript script or Java) that may run on the client computer.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of rendering a web page on display devices of different sizes, in accordance with one example embodiment;

FIG. 2 is a diagrammatic representation of example architecture within which method and system for redisplaying a web page, in accordance with one example embodiment;

FIG. 3 is a block diagram of a system for redisplaying a web page, in accordance with one example embodiment;

FIG. 4 is a flow chart of a method for redisplaying a web page, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Web pages, when presented on a smaller-size display device may be difficult to view because of the reduced size. A user may be able to zoom in on a particular area of a web page and then pan out to view the entire page again. This approach may not be always convenient, especially where a web page is a complex collection of text, images and links related to different subjects or topics.

Adaptive client-site rendering of a web page is described. In one example embodiment, a module termed a smart viewer may be embedded in a web page. A smart viewer may be configured to redisplay the content provided on the web page in a manner that permits a user to easily access and view different portions of the web page. A web page may be perceived by a view as containing a collection of discreet sections. For example, a web page representing an on-line magazine or a news letter may display the main article, a local events article, a weather report, and a list of links to other web pages.

A smart viewer may be configured to analyze the structured text of a web page to identify a plurality of content sections into which the web page may be logically broken, anticipating that a user may be interested in viewing each or at least some of these determined sections as a separate web page that is presented in a way that it occupies the entire display area on a web browser application, while other sections of the web page are not displayed and remain hidden. The smart viewer may then generate an index view of the web page, e.g., presenting the web page as a collection of thumbnail images or a list of links, where each thumbnail image or link corresponds to one of the determined web page sections. When a user activates a thumbnail or a link (e.g., by touching the corresponding area on the screen, pressing a predetermined key on a keypad, or performing some other predetermined control operation), the smart viewer replaces the indexed view of the web page with a view of the associated section (a section view) of the web page that has been resized to fit the entire or most of the viewing area of the browser application. The resizing may be accomplished by applying a CCS style to the portion of the web page that corresponds to the associated section. While the section view is presented on the viewing area, other parts of the web page are being hidden.

In order to generate an index view of the web page, based on the determined sections, the smart viewer analyzes the structured and styled content in a section to determine text or image that would serve as representation of the section in a way that the section would be recognized by a user even if it is presented in a thumb nail form. For example, where shrinking the entire section to a thumb nail size would make the section topic less recognizable to a viewer, a thumb nail may be generated that shows just some of the text or just one image or part of an image. The smart viewer may be configured to perform semantic analysis of the web page to identify or generate text or image that may be viewed as representative of the section.

From an index view, a user could add/remove sections of interest to a tab view with user tagging for tab labels. The tab view configuration can be stored so that the tab view, representing only selected sections, will become default view on subsequent page loading for same web page. The default tab view configuration may also be supplied by web page itself if the content providers choose to do so. A viewer may be able to toggle between the index view, tab view, section view and original full page view.

In one example embodiment, a smart viewer may be implemented as a Java Script (JS) script. A web page received at a client device may already include a smart viewer module. A browser plug-in (or extension) may be provided at a client device termed, e.g., a smart viewer plug-in to permit redisplaying of web pages that do not include a smart viewer module. A smart viewer plug-in may be configured to inject a smart viewer module into a web page. A smart viewer module that can be injected into a web page may be stored at a client device or it may be downloaded by the smart viewer plug-in onto the client device each time a web page is provided to the client device.

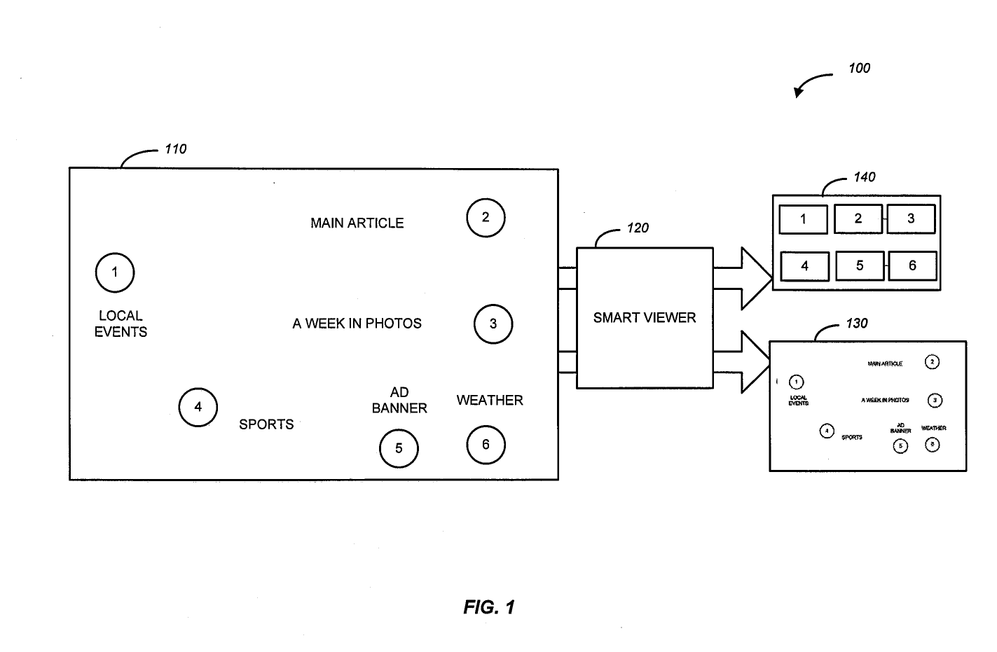

FIG. 1 illustrates a view 100 of an original web page and of a redisplayed web page rendered on a smaller-size screen. A representation 110 of a web page includes information related to several topics, such as “Local Events” (1), “Main Article” (2), “A Week in Photos” (3), “Sports” (4), “Ad Banner” (5), and “Weather” (65). As shown in FIG. 1, the representation 110 does not include dividing lines demarcating different sections, and yet the representation 110 may be perceived by a viewer as comprising several discreet sections (i.e., related to the main article, local events, etc.). A representation 130 is a view of the web page when rendered on a smaller-size display device. Any text or graphics that appears in the representation 110 also appears in the representation 130, only in a reduced size, which may make it difficult for a user to read the text or otherwise use the information presented on the web page. A representation 140 is an index view of the web page, where the web page is presented as a collection of discreet references to respective sections. An index view of a web page may be provided in the form of thumbnails (as in the representation 140), a list of titles, etc.

As the perceived sections of a web page may not necessarily be identified as discreet sections in the associated HTML text, a smart viewer module may be utilized to analyze the HTML DOM (document object model) text of the web page and to determine a plurality of sections that constitute the web page. A redisplayed version of the web page may comprise actionable sections, where, e.g., clicking on or otherwise activating a representation of a section causes the browser application to render a section view of the web page, where the section is displayed in a way that it occupies substantially the entire real estate of the display area of the client device. In FIG. 1, a redisplayed version of the web page shown as the representation 110 may appear as a collection of thumbnails (as in the representation 140), or as a reduced-size version of the web page (as in the representation 130).

When a web page is redisplayed to provide an index view of the determined sections, a smart viewer may be utilized to analyze the HTML DOM (document object model) elements of the web page sections to generate a representative view of each section to be displayed in the index view. For example, where an index view is a thumbnail view, a thumbnail representing a weather section of the web page may include the title “WEATHER,” a logo identifiable as related to weather, etc., without displaying the entire content of the weather section as it appears in the original web page. An abbreviated representative contents may be redisplayed with readable font-size and similar display style (positions, layout, color scheme, etc). Alternatively, a reduced-size view of the web page area that corresponds to the section maybe displayed in a corresponding thumbnail in the index view. When a web page is redisplayed without providing an index view of the determined sections, a user may still be provided with the functionality where clicking on an area of the representation 130 that corresponds to a certain determined section causes the browser application to render a section view of the web page, where the certain determined section is displayed in a way that it occupies substantially the entire real estate of the display area of the client device.

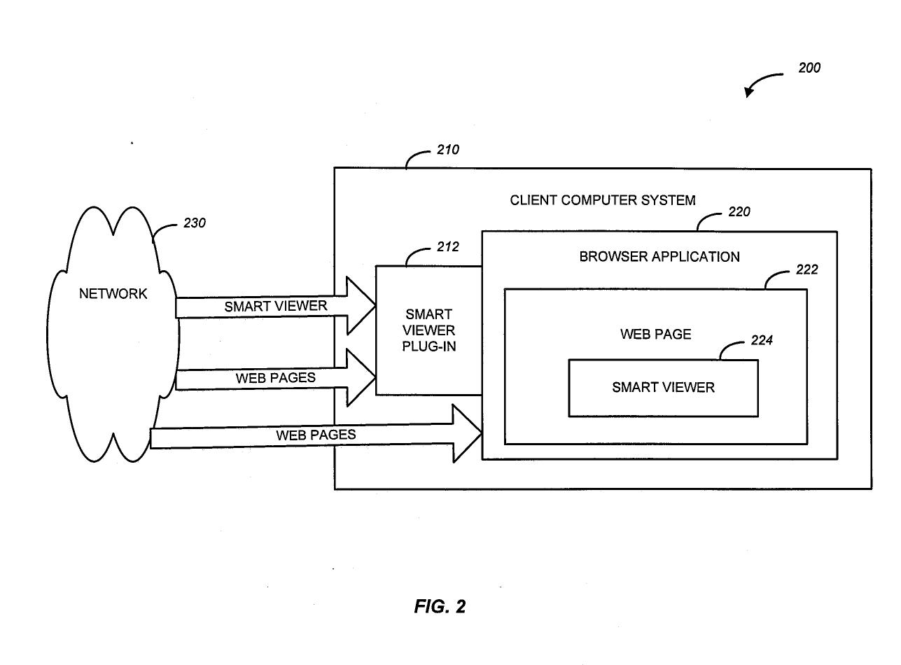

Example architecture 200 of method and system for redisplaying a web page may be described with reference to FIG. 2. As shown in FIG. 2, the architecture 200 comprises a client computer system 210 hosting a browser application 220 configured to display web pages such as, e.g., a web page 222. Web pages may be provided to the browser application 220 utilizing a network 230. The web page 222 is shown as including a smart viewer module 224. As described above, the smart viewer 224 may be configured to analyze structured and styled content (e.g., HTML DOM) of the web page to determine sections that constitute the web page in order to enable rendering a single discreet section of the web page while hiding other sections of the web page. In one embodiment, default heuristic algorithm can be used by smart viewer to break entire web page to sections of display area which could be nested for some sections. The heuristic algorithm utilized following, but not limited to, factors to extract meaningful sections: (1) its displaying dimension relative to its containing parent section, (2) position relative to its sibling sections, (3) its containment elements and/or sub-sections, (4) locale/culture based information presentation pattern, such as, left to right, top to bottom, (5) standard semantic elements if presented, such as, header, footer, nav, section, article, aside, etc, in HTML 5. The smart viewer module could further incorporate customization extension based on DOM attributes, HTML id and class attributes. The smart viewer 224 may also be configured to generate, for each determined section, a representative view of the section that may be useful for identifying respective sections in the index view. The representative information for each session can be extracted heuristically based on following, but not limited to, factors: (1) content types, such as, text, link, image, etc., (2) relative positions, (3) display style and emphasis, such as, font-size, font-style, color, (4) image aspect ratio, (5) text length, (6) standard semantic elements if presented, such as, header, footer, article, dialog, figure, strong, em, etc., in HTML 5. The smart viewer module could further incorporate customization extension based on DOM attributes, HTML id and class attributes for semantic determination.

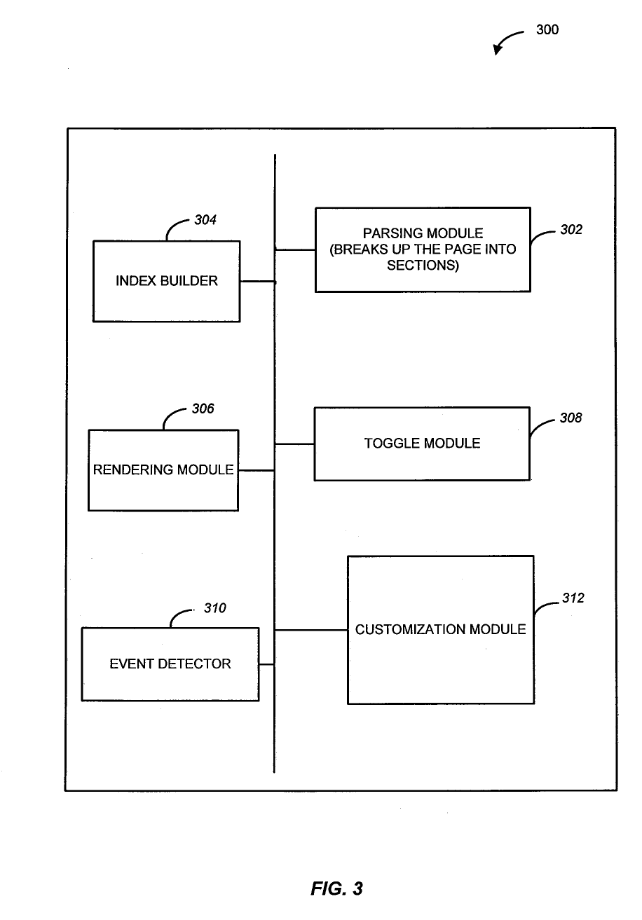

As mentioned above, the smart viewer 224 may be included in a web page when it is first received at the client computer system 210. A web page received at the client computer system 210 may be provided without a smart viewer. The client computer system 210 may host a smart viewer plug-in 212 configured to inject a smart viewer into a web page. The smart viewer plug-in 212 may access a smart viewer that is stored on the client computer system 210. Alternatively, the smart viewer plug-in 212 may be configured to download a smart viewer each time a web page is received at the client computer system 210 and inject the downloaded smart viewer into the received web page. An example system for redisplaying a web page including modules provided as part of a smart viewer may be described with reference to FIG. 3.

FIG. 3 is a block diagram of a system 300 configured to redisplay web pages, in accordance with one example embodiment. The system 300 may be utilized advantageously, e.g., when a web page designed for a larger-size display device is to be displayed on a smaller-size display device such as, e.g., a mobile phone display device. Some of the modules of the system 300 may be part of a smart viewer injected into a web page, while some modules, may be provided by a browser application. Various modules shown in FIG. 3 may be implemented as software, hardware, or a combination thereof.

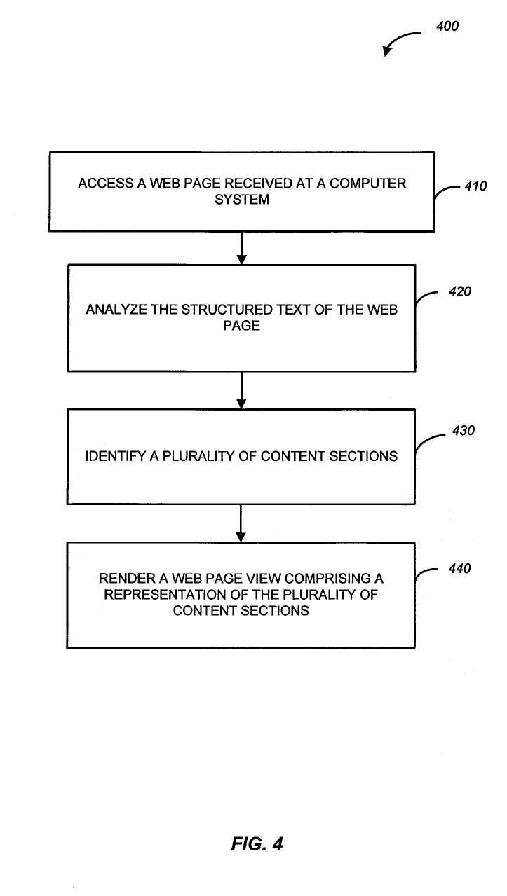

As shown in FIG. 3, the system 300 includes a parsing module 302, a parsing module 302, an index builder 304, a rendering module 306, a toggle module 308, an event detector 310, and a customization module 312. The parsing module 302 may be configured to access a web page on a computer system, analyze the structured and styled DOM of the web page, and, based on the analyzing, identify a plurality of sections that constitute the web page. Sections that constitute the web page content sections. The index builder 304 may be configured to generate an index representation of the plurality of sections. The index builder 304 may also be configured to determine representative information for each section of the plurality of sections and, based on analyzing of the structured DOM, to extract semantic relationship among them. The rendering module 306 may be configured to render web page views on a display device of the computer system. The toggle module 308 may be configured to permit toggling between section view, tabbed section view(s), index view, and original full page view. For example, the toggle module 308 may be configured to cooperate with the event detector 310 that detects a toggle event and, in response, replace the section view with the index view. The event detector 310 may be configured to detect other events such as an event indicative of a request to render section view of a particular section of a web page. The customization module 312 may be configured to render, on the display device a modified web page view responsive to a customization request, the modified web page view lacking the representation of the first section, such as, e.g., a tab view with only pre-selected sections. An example method utilizing the system 300 may be described with reference to FIG. 4.

FIG. 4 is a flow chart of a method 400 for redisplaying web pages, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the client computer system 210 of FIG. 2 and, specifically, at the system 300 shown in FIG. 3.

As shown in FIG. 4, the method 400 commences at operation 410, when the parsing module 302 of FIG. 3 accesses a web page received at a computer system. At operation 420, the parsing module 302 analyzes the structured text of the web page and identifies a plurality of content sections at operation 430. At operation 440, the rendering module renders a web page view comprising the plurality of sections.

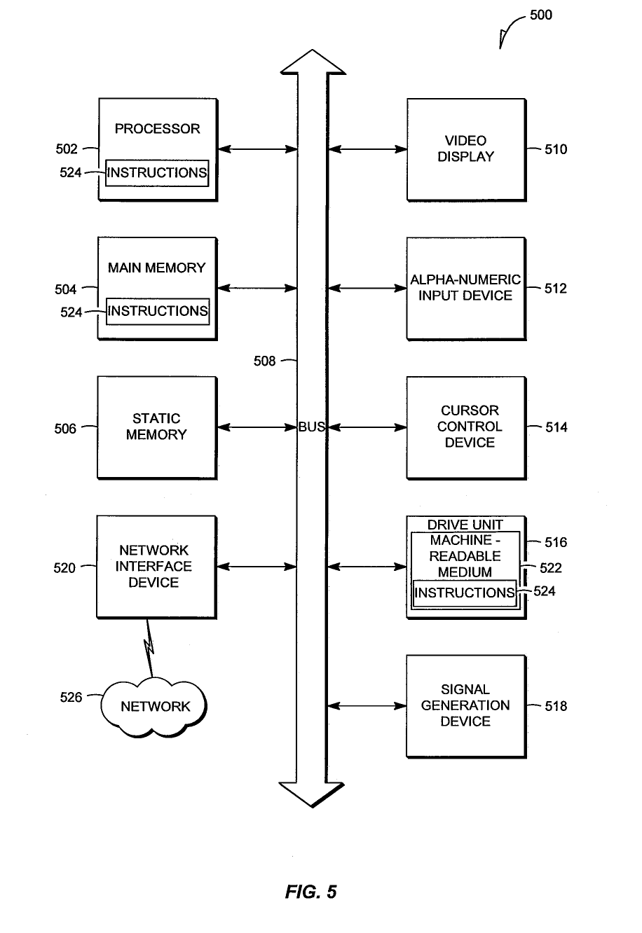

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a method and system for redisplaying a web page has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A method comprising:
accessing a web page received at a computer system, the web page represented comprising structured text;
analyzing the structured text of the web page;
based on the analyzing, identifying a plurality of content sections, the web page comprising the plurality of content sections;
rendering, on a display device of the computer system, a web page view, the web page view comprising a first representation of a first section from the plurality of content sections, the first representation being actionable to cause rendering of a second representation of the first section and to cause hiding respective representations of other sections from the plurality of sections.

2. The method of claim 1, wherein the web page view comprising the first representation of a first section is an index representation of the plurality of sections.

3. The method of claim 2, wherein the index representation of the plurality of sections comprises respective thumb nail representations of the plurality of sections.

4. The method of claim 2, comprising based on the analyzing, determining representative information for each section of the plurality of sections.

5. The method of claim 1, comprising:
detecting a section view request event associated with the first representation of the first section;
responsive to the section view request event, replace the web page view with a section view, the section view presenting the first section while hiding other sections from the plurality of sections.

6. The method of claim 5, comprising:
responsive to a toggle event, replacing the section view with the web page view.

7. The method of claim 1, comprising:
responsive to a customization request, rendering on the display device a modified web page view, the modified web page view lacking the representation of the first section.

8. The method of claim 1, wherein the structured text is HyperText Markup Language (HTML) text.

9. The method of claim 1, comprising injecting, using a browser plug-in, a smart viewer module into the structured text of the web page.

10. The method of claim 1, wherein the computer system is a mobile device.

11. A computer-implemented system comprising:
a parsing module to:
access a web page received at a computer system, the web page represented comprising structured text,
analyze the structured text of the web page, and
based on the analyzing, identify a plurality of content sections, the web page comprising the plurality of content sections; and
a rendering module to render, on a display device of the computer system, a web page view, the web page view comprising a first representation of a first section from the plurality of content sections, the first representation being actionable to cause rendering of a second representation of the first section and to cause hiding respective representations of other sections from the plurality of sections.

12. The system of claim 11, comprising an index builder to generate an index representation of the plurality of sections, wherein the web page view is the index representation of the plurality of sections.

13. The system of claim 12, wherein the index representation of the plurality of sections comprises respective thumb nail representations of the plurality of sections.

14. The system of claim 12, wherein the index builder is to determine representative information for each section of the plurality of sections, based on analyzing of the structured text of the web page.

15. The system of claim 11, comprising an event detector to detect a section view request event associated with the first representation of the first section, wherein the rendering module is to replace the web page view with a section view responsive to the section view request event, the section view presenting the first section while hiding other sections from the plurality of sections.

16. The system of claim 15, comprising a toggle module to replace the section view with the web page view responsive to a toggle event.

17. The system of claim 11, comprising a customization module to render, on the display device a modified web page view responsive to a customization request, the modified web page view lacking the representation of the first section.

18. The system of claim 11, wherein the structured text is HyperText Markup Language (HTML) text.

19. The system of claim 11, wherein the computer system is a mobile device.

20. A machine-readable non-transitory medium having instruction data to cause a machine to:
access a web page received at a computer system, the web page represented comprising structured text;
analyze the structured text of the web page;
based on the analyzing, identify a plurality of content sections, the web page comprising the plurality of content sections; and
render, on a display device of the computer system, a web page view, the web page view comprising a first representation of a first section from the plurality of content sections, the first representation being actionable to cause rendering of a second representation of the first section and to cause hiding respective representations of other sections from the plurality of sections.
